(19) United States
(12) Patent Application Publication
(10) Pub. No.: US 2018/0288216 A1
(43) Pub. Date: Oct. 4, 2018

(54) OUT GOING ONLY

(71) Applicant: Denita Duncan, Los Angeles, CA (US)

(72) Inventor: Denita Duncan, Los Angeles, CA (US)

(21) Appl. No.: 15/940,973

(22) Filed: Mar. 30, 2018

Related U.S. Application Data
(60) Provisional application No. 62/479,318, filed on Mar. 31, 2017.

(51) Int. Cl. H04M 1/725; H04W 4/90

(52) U.S. Cl. CPC H04M 1/72577; H04W 4/90

(57) ABSTRACT

An improved cellular communications device having a keyboard, an LCD screen, a microphone, a speaker, a computer processor, and a transmitter, the improvement comprising a computer application programmed with up to six telephone numbers, and configured to only make outgoing calls to these specifically programmed contacts, unless purposely unlocked by a parent or caregiver. Excluding internet access and other smartphone frills structured and arranged to provide children and adults with an easy-to-use cellular device that facilitates voice communication without all of the distractions and interruptions common to traditional cellular phones.

### CROSS-REFERENCE TO RELATED APPLICATION

The present application is related to and claims priority from prior provisional application Ser. No. 62/479,318, filed Mar. 31, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of emergency alert systems and more specifically relates to a cellular communications device having a keyboard, an LCD screen, a microphone, a speaker, a computer processor, and a transmitter, the improvement comprising a computer application programmed with up to six telephone numbers, and configured to only make outgoing calls to these specifically programmed contacts, unless purposely unlocked by a parent or caregiver.

### 2. Description of the Related Art

One the most explosive new technologies to come out of the last twenty years is the cellular telephone. In 1994, 16 million Americans were subscribers to cellular phone services. By 2002, that number had ballooned to more than 110 million, and still shows no sign of slowing down. In fact, some experts predicted that worldwide subscribership reached 1.2 billion people by the end of 2012. Today's widespread use of these revolutionary devices is unsurprising, since they now offer a virtually endless array of benefits.

Perhaps the only drawback associated with owning cellular telephones is that these devices can be quite a distraction. This is especially true for children and teens who are easily lured by the fun and convenience of these devices and thus spend hours during the day chatting on the phone with their friends, sending text messages or even surfing the internet and accessing social networks, all with this one device. In addition, many consumers, particularly those who were alive before cellular technology took over the global airwaves, simply do not appreciate the annoying interruptions common to carrying a cellular telephone. Simply stated, incoming calls can come at any time, day or night and nothing is so disturbing as being awoken from a peaceful nap, or even being interrupted while enjoying an afternoon outing with friends, by the piercing ringing of a cellular phone.

Further, many consumers simply find the sophisticated nature of today's cellular telephones to be rather oft-putting and the complicated process of learning how to utilize a cell phone can hardly seem worth the effort. Unfortunately, not allowing a child to carry a cellular telephone in order to prevent them from wasting precious time enraptured by the many features of one of these devices, or simply choosing to forgo a cellular phone because one does not appreciate the constant interruptions associated with carrying one on the person, can have serious consequences in an emergency situation.

Simply stated, should a child, or even an adult user become lost or experience a vehicle breakdown or other emergency, having a cellular telephone on hand can prove invaluable, enabling the user to seek assistance in a quick and easy manner. Without a cellular telephone on hand, that person is literally stranded, having no other choice to seek assistance from strangers: a sometimes dangerous scenario. As such, most people give in to the pressure of carrying a cellular telephone, rather than risk being without one when needed.

Various attempts have been made to solve problems found in emergency alert systems art. Among these are found in: U.S. Pat. No. 7,092,695 to Brian M. Boling et al; U.S. Pat. No. 7,181,192 to Carl M. Panasik et al; U.S. Pat. No. 5,365,570 to Mark J. Boubelik. This prior art is representative of emergency only cellular telephones.

Ideally, an improved cellular communications device having a keyboard, an LCD screen, a microphone, a speaker, a computer processor, and a transmitter should be user-friendly and safe in-use and yet should operate reliably and be manufactured at a modest expense. Thus, a need exists for a cellular communications device having a keyboard, an LCD screen, a microphone, a speaker, a computer processor, and a transmitter, the improvement comprising a computer application programmed with up to six telephone numbers, and configured to only make outgoing calls to these specifically programmed contacts, unless purposely unlocked by a parent or caregiver. Excluding internet access and other smartphone frills structured and arranged to provide children and adults with an easy-to-use cellular device that facilitates voice communication without all of the distractions and interruptions common to traditional cellular phones and to avoid the above-mentioned problems.

### BRIEF SUMMARY OF THE INVENTION

In view of the foregoing disadvantages inherent in the known emergency alert systems art, the present invention provides an Improved Cellular Communications Device having a keyboard, an LCD screen, a microphone, a speaker, a computer processor, and a transmitter (Entitled Outgoing Only). The general purpose of the present invention, which will be described subsequently in greater detail is to provide an improved cellular communications device having a keyboard, an LCD screen, a microphone, a speaker, a computer processor, and a transmitter, the improvement comprising a computer application programmed with up to six telephone numbers, and configured to only make outgoing calls to these specifically programmed contacts, unless purposely unlocked by a parent or caregiver. Excluding internet access and other smartphone frills structured and arranged to provide children and adults with an easy-to-use cellular device that facilitates voice communication without all of the distractions and interruptions common to traditional cellular phones.

In a cellular communications device having a keyboard, an LCD screen, a microphone, a speaker, a computer processor, and a transmitter, the improvement comprising a computer application. The computer application is programmed into the computer processor and is adapted to store information for up to six emergency contacts. Wherein the computer application is adapted to lock the information for up to six emergency contacts. Wherein the computer application is adapted to unlock the information for up to six emergency contacts via a four digit pin code entered via the keyboard. Wherein the transmitter is adapted to send information to a GPS system. Wherein the cellular communications device is adapted such that it cannot receive incoming communications.

The present invention holds significant improvements and serves as an Improved Cellular Communications Device having a keyboard, an LCD screen, a microphone, a speaker, a computer processor, and a transmitter. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an Improved Cellular Communications Device having a keyboard, an LCD screen, a microphone, a speaker, a computer processor, and a transmitter (Entitled Outgoing Only), constructed and operative according to the teachings of the present invention.

FIG. 1 shows a perspective view illustrating an Improved Cellular Communications Device according to an embodiment of the present invention.

FIG. 2A is a perspective view illustrating the Improved Cellular Communications Device in a locked condition according to an embodiment of the present invention of FIG. 1. (Show cover closed)

FIG. 2B is a perspective view illustrating the Improved Cellular Communications Device in a locked condition according to an embodiment of the present invention of FIG. 1. (Show user enter in 4 digit code into keypad to unlock phone)

FIG. 3 shows a perspective view illustrating a belt clip of the Improved Cellular Communications Device according to an embodiment of the present invention.

FIG. 4 is a perspective view illustrating the Improved Cellular Communications Device having touch-screen technology according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a walking aid device and more specifically relates to an Improved Cellular Communications Device having a keyboard, an LCD screen, a microphone, a speaker, a computer processor, and a transmitter (Entitled Outgoing Only) comprising a computer application programmed with up to six telephone numbers, and configured to only make outgoing calls to these specifically programmed contacts, unless purposely unlocked by a parent or caregiver. Excluding internet access and other smartphone frills structured and arranged to provide children and adults with an easy-to-use cellular device that facilitates voice communication without all of the distractions and interruptions common to traditional cellular phones

Generally speaking, the Out Going Only comprises a specially designed emergency cellular device, with the unit configured expressly to be programmed to make outgoing calls to up to six, emergency contacts. Importantly, the Out Going Only would be a very basic model cellular telephone that is unable to accept incoming calls, send text messages or access the internet, thus effectively eliminating the distractions and interruptions common to cellular telephones. The present invention also will display the time in digital form.

The Out Going Only is.configured expressly for use by children, teens, seniors, as well as those with various special needs, the Out Going Only would be rectangular in shape, and comparable in size to other cell phones. The Out Going Only will feature a simple alphanumeric keypad for use in programming the phone with contact information; a liquid crystal display screen; integrated microphone incorporated into the unit mouthpieces; and an integrated speaker incorporated into the device's earpiece. (A full touch screen version could be produced for adult use.) The six, red, outer push-buttons of the keypad, three on each side vertically, would be allocated for the user's contacts.

Although the user (person in control of the device) could program the device with virtually any contacts deemed appropriate, the user might choose to program the first contact with the number of a nearby parent or grandparent; the second contact, with the number of a close by Uncle or family member; the third, with a counselor, mentor, or caretaker's number; the fourth, with a friend or relative's number who lives in a neighboring city; the fifth, with an out-of-state contact; and so on, as suggested by the inventor. Once programmed, the contact information could be “locked” into the phone, with the user creating and entering a four-digit pin code in order to prevent others (such as children or special needs individuals) from reprogramming or accidentally deleting the contact numbers in their phones.

Parents and caretakers will also have the option of leaving the phone “open,” so that any call can be made, specific or non-specific. A voice activated retrieving system would also be included should one misplace their phone, and the Out Going Only will include GPS so that the phone, or the phone's user, could be located if necessary. This phone could be powered by way of an internally contained rechargeable battery, with a simple charger cord included for sale with the unit. A removable belt clip would also be included.

The Out Going Only would offer consumers a sensible alternative to traditional cellular telephones and one which would enable them to easily connect with others as a means of simple communication. Parents of children and teens, as well as special needs adults, should appreciate that they could provide their child with a phone to call home and communicate with loved ones without risking their safety by receiving incoming calls, text messages and internet access. (Not to mention the associated data costs).

Providing a measure of freedom and independence to children, and adults with special needs as well, this phone would enable these individuals to enjoy the benefits of having a cellular phone on hand, without being distracted by these devices, or receiving unwelcome calls or solicitations. Further, the Out Going Only should be appreciated by those technologically challenged older adults and seniors who have not caught on to the cell phone craze. Simple in design, consumers should appreciate the ease of which this device could be programmed and utilized, providing users with a very simple communication device which can be easily used by everyone.

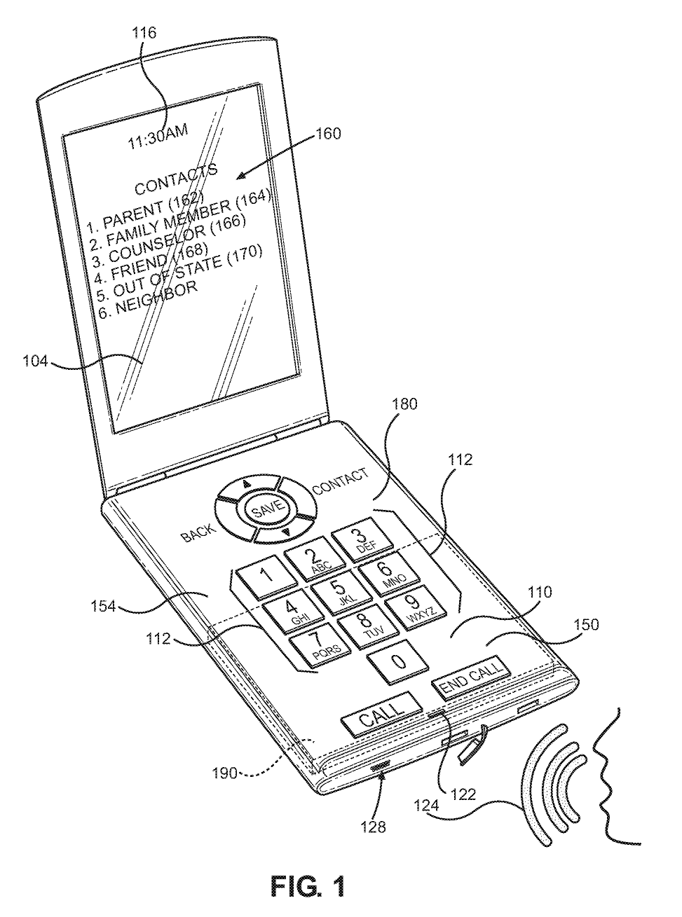

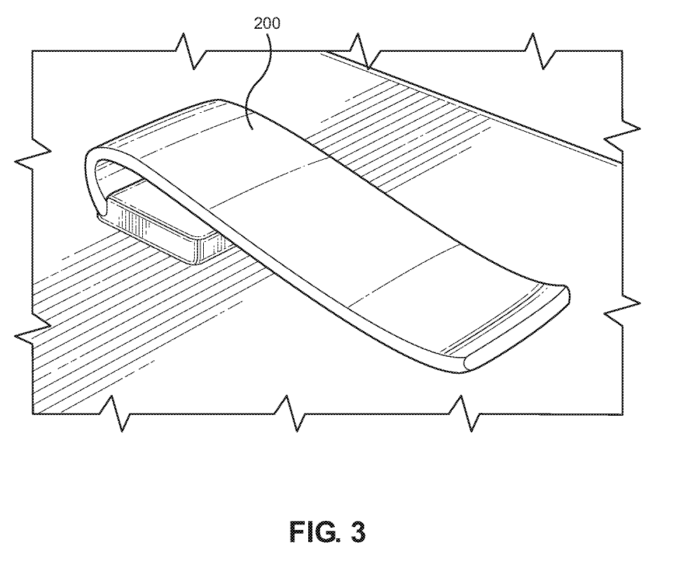

Referring now to FIGS. 1-4, showing perspective views illustrating improved cellular communications device 100 according to an embodiment of the present invention of FIG. 1.

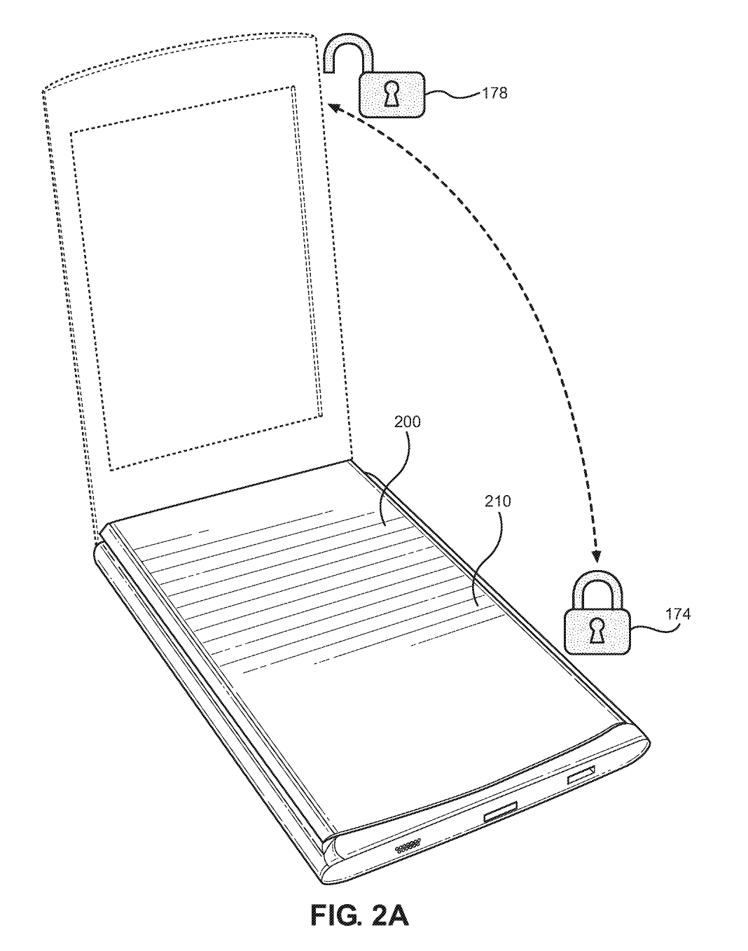

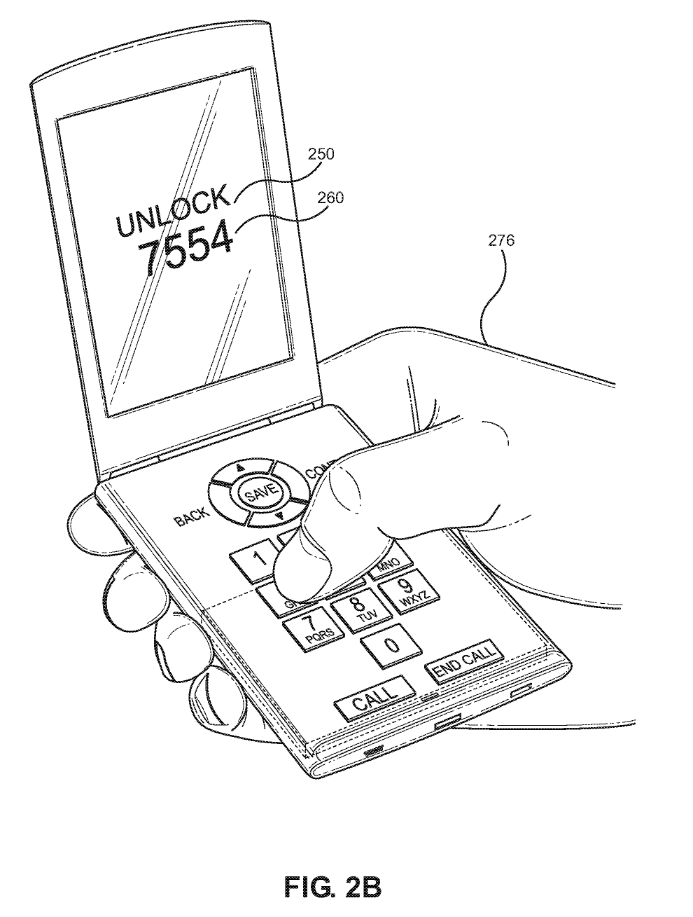

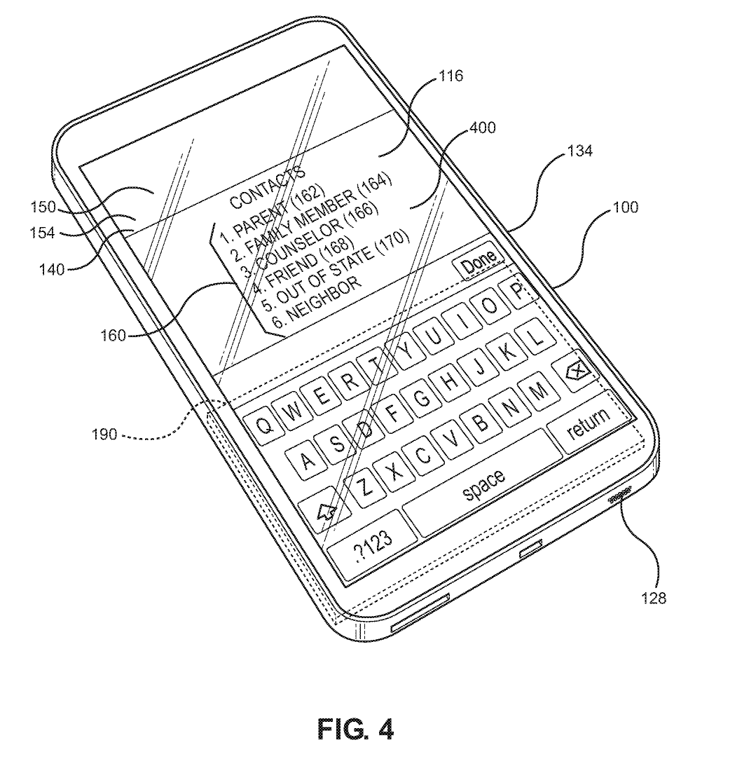

In improved cellular communications device 100 having keyboard 110, LCD screen 116, microphone 122, speaker 128, computer processor 134, and transmitter 140, the improvement comprising computer application 150. Computer application 150 is programmed into computer processor 154 and is adapted to store information for up to six emergency contacts 160. Wherein emergency contacts 160 includes first contact 162 for a parent or grandparent; second contact 164 for a family member within a predetermined area; third contact 166 for a counselor, mentor, or caretaker; fourth contact 168 for a friend or family member within a predetermined city; and fifth contact 170 for an out-of-state contact. Wherein improvement 100 further comprises LCD screen 116 being adapted to display time 118 in digital form 120.

Wherein improvement further comprise keyboard 110 incorporating six push buttons 112 adapted to retrieve respective said six emergency contacts 160. Wherein six push buttons 112 are formed having a red color for easy identification.

Wherein the computer application 150 is adapted to lock the information 210 for up to six emergency contacts 160 as shown in locked condition 200 of FIG. 2A. Wherein computer application 150 is adapted to unlock the information 250 for up to six emergency contacts via a four digit pin code 260 entered via keyboard 110 as shown in unlocked condition 270 of FIG. 2B. Wherein computer application 150 is further adapted such that calls can only be made to up to six emergency contacts 150.

Wherein transmitter 140 is adapted to send information to a GPS system. Wherein cellular communications device 100 is adapted such that it cannot receive incoming communications 180. Wherein computer application 150 is further adapted such that location 104 of cellular communications device 100 can be achieved via voice activation 124 via microphone 122 and an audio signal via speaker 128. Wherein improvement 100 further comprises rechargeable battery member 190. Wherein improvement 100 further comprises belt clip 300 attached to cellular communications device 100 and adapted to removably clip to an article of clothing of a user.

Wherein improvement 100 further comprises LCD screen being adapted to include touch-screen technology 400 as shown in FIG. 4.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. In a cellular communications device having a keyboard, an LCD screen, a microphone, a speaker, a computer processor, and a transmitter, the improvement comprising:
a computer application;
wherein said computer application is programmed into said computer processor and is adapted to store information for up to six emergency contacts;
wherein said computer application is adapted to lock said information for said up to six emergency contacts;
wherein said computer application is adapted to unlock said information for said up to six emergency contacts via a four digit pin code entered via said keyboard;
wherein said transmitter is adapted to send information to a GPS system;
wherein said cellular communications device is adapted such that it cannot receive incoming communications.

2. The cellular communications device of claim 1, wherein said computer application is further adapted such that calls can only be made to said up to six emergency contacts.

3. The cellular communications device of claim 1, wherein said computer application is further adapted such that said location of said cellular communications device can be achieved via voice activation via said microphone and an audio signal via said speaker.

4. The cellular communications device of claim 1, wherein said improvement further comprises a rechargeable battery member.

5. The cellular communications device of claim 1, wherein said improvement further comprises a belt clip attached to said cellular communications device and adapted to removably clip to an article of clothing of a user.

6. The cellular communications device of claim 1, wherein said emergency contacts includes a first contact for a parent or grandparent; a second contact for a family member within a predetermined area; a third contact for a counselor, mentor, or caretaker; a fourth contact for a friend or family member within a predetermined city; and a fifth contact for an out-of-state contact.

7. The cellular communications device of claim 1, wherein said improvement further comprises said LCD screen being adapted to display time in a digital form.

8. The cellular communications device of claim 1, wherein said improvement further comprises said LCD screen being adapted to include touch-screen technology.

9. The cellular communications device of claim 1, wherein said improvement further comprises said keyboard incorporating six push buttons adapted to retrieve respective said six emergency contacts.

10. The cellular communications device of claim 9, wherein said six push buttons are formed having a red color for easy identification.
